(19) United States
(12) Patent Application Publication
(10) Pub. No.: US 2025/0122316 A1
(43) Pub. Date: Apr. 17, 2025

(54) CURABLE COMPOSITION AND CURED PRODUCT

(71) Applicant: DEXERIALS CORPORATION, Tochigi (JP)

(72) Inventors: Shunsuke TSUDA, Tochigi (JP); Takeshi NISHIO, Tochigi (JP)

(21) Appl. No.: 18/574,456

(22) PCT Filed: Jun. 30, 2022
(86) PCT No.: PCT/JP2022/026246

§ 371 Date: Dec. 27, 2023

(30) Foreign Application Priority Data
Jul. 9, 2021 (JP) 2021-113966

(51) Int. Cl. C08F 122/14; C08F 2/30; C08F 2/44; C08F 120/68; C08F 222/10; C08K 5/00; C08K 5/5415; C08K 5/55; C08L 35/00

(52) U.S. Cl. CPC C08F 122/14; C08F 2/44; C08F 120/68; C08F 222/102; C08F 222/103; C08K 5/0091; C08K 5/5415; C08K 5/55; C08L 35/00; C08F 2/30; C08L 2205/22

(57) ABSTRACT

A curable composition that includes a polymerizable monomer, an aluminum chelate compound, a silanol compound, and a quaternary boron-containing onium salt.

### TECHNICAL FIELD

The present invention relates to a curable composition and a cured product.

### BACKGROUND ART

A curable composition including a polymerizable monomer has been widely used, for example, for coating, adhesives, etc., and a cured product obtained with the curable composition has excellent characteristics, such as abrasion resistance, adhesion, weather resistance, and the like.

As the above-described curable composition, for example, a thermally curable composition including a cationic curing component, a specific ammonium salt, and a radical generator has been proposed. In the proposed technology, it is disclosed that an organic peroxide serving as the radical generator generates an acid, and the generated acid is used to cure a cationic curable component, such as an epoxy resin (see, for example, PTL 1).

Moreover, an adhesive composition including a cationic polymerizable compound, an aluminum chelate-silanol-based curing catalyst, and an episulfide compound is proposed. In the proposed technology, it is disclosed that cation species and anion species generated as active species by the aluminum chelate-silanol-based curing catalyst act together to initiate cationic polymerization of the cationic polymerizable compound (see, for example, PTL 2).

### CITATION LIST

### Patent Literature

PTL 1: Japanese Unexamined Patent Application Laid-Open (JP-A) No. 2016-166306
PTL 2: Japanese Unexamined Patent Application Laid-Open (JP-A) No. 2021-4363

### SUMMARY OF INVENTION

### Technical Problem

However, the compositions of PTLS 1 and 2 include neither a radically polymerizable monomer nor a quaternary boron-containing onium salt. Therefore, the compositions of PTLs 1 and 2 do not have a mechanism where a curable composition is heated to react an aluminum chelate compound and a silanol compound to generate an acid, the generated acid reacts with the quaternary boron-containing onium salt to generate radicals, and the generated radicals induce polymerization of the radically polymerizable monomer.

Moreover, a curable composition including a radically polymerizable monomer has a problem such that light for light irradiation cannot reach an intended region of the curable composition to cause curing failures or difficulty in curing when ultraviolet ray (UV) curing is performed for use in adhesion of optical members and the like.

The present invention aims to solve the above-described various problems existing in the related art and to achieve the following object. Specifically, the present invention relates to a curable composition having excellent curability as heated and a cured product using the curable composition.

### Solution to Problem

Means for solving the above-described problems are as follows.

<1>A curable composition, including:
a polymerizable monomer;
an aluminum chelate compound;
a silanol compound; and
a quaternary boron-containing onium salt.
   <2> The curable composition according to <1>,
   wherein the polymerizable monomer is a radically polymerizable monomer including a carbon-carbon double bond in a molecule of the radically polymerizable monomer.
   <3> The curable composition according to <1> or <2>,
   wherein the polymerizable monomer is a (meth)acrylate.
   <4> The curable composition according to any one of <1> to <3>, further including:
porous particles,
   wherein the aluminum chelate compound is borne on the porous particles.
   <5> The curable composition according to <4>,
   wherein the porous particles are each formed of a polyurea resin.
   <6> The curable composition according to any one of <1> to <5>, wherein the quaternary boron-containing onium salt is represented by General Formula (1) below,

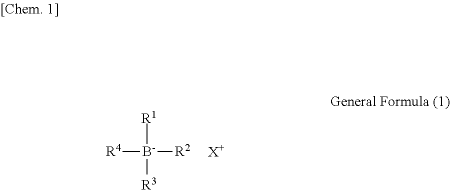

where, in General Formula (1), at least one of R¹ to R⁴ is a phenyl group or naphthyl group that may have a substituent, and the rest of R¹ to R⁴ are each an alkyl group that may have a substituent, or a phenyl group or naphthyl group that may have a substituent; and X⁺ is an ammonium cation, a sulfonium cation, a pyridinium cation, a phosphonium cation, an oxonium cation, or an iodonium cation.
<7> The curable composition according to any one of <1> to <6>, wherein the silanol compound is an arylsilanol compound represented by General Formula (6) below,

[Chem. 2]

(Ar)ₘSi(OH)ₙ General Formula (6)

where, in General Formula (6), m is 2 or 3, where a sum of m and n is 4; and Ar is an aryl group that may have a substituent.
<8> The curable composition according to any one of <1> to <7>, wherein an amount of the polymerizable monomer is 80% by mass or greater and 97% by mass or less.
<9> The curable composition according to any one of <1> to <8>, wherein an amount of the aluminum chelate compound is 0.1% by mass or greater and 10% by mass or less.
<10> The curable composition according to any one of <1> to <9>, wherein an amount of the silanol compound is 0.1% by mass or greater and 10% by mass or less.
<11> The curable composition according to any one of <1> to <10>,
wherein an amount of the quaternary boron-containing onium salt is 0.1% by mass or greater and 5% by mass or less.
<12>A cured product, including:
a cured product of the curable composition according to any one of <1> to <11> that is cured by heating.

### Effects of Invention

According to the present invention, the above-described various problems existing in the related art can be solved; the above-described object can be achieved; and a curable composition having excellent curability as heated and a cured product using the curable composition can be provided.

### DESCRIPTION OF EMBODIMENTS

### (Curable Composition)

The curable composition of the present invention includes a polymerizable monomer, an aluminum chelate compound, a silanol compound, and a quaternary boron-containing onium salt. The curable composition may further include other components, as necessary.

In the present invention, as the curable composition is heated, the aluminum chelate compound and the silanol compound react with each other to generate an acid. The generated acid reacts with the quaternary boron-containing onium salt so that a phenyl group or naphthyl group bonded to B⁺ of the quaternary boron-containing onium salt is released to generate a radical. The generated radical induces polymerization of the polymerizable monomer to form a polymer. Therefore, curability of the curable composition as heated is improved. As a result, when ultraviolet ray (UV) curing is performed on the curable composition used for adhering optical members, the following problems can be solved. The problems are such that curing defects or difficulty in curing is caused because light for light irradiation does not reach an intended region of the curable composition.

Moreover, use of porous particles bearing the aluminum chelate compound, instead of the aluminum chelate compound alone, can assure excellent pot life of the curable composition without causing an instant reaction of the curable composition.

### <Polymerizable Monomer>

The polymerizable monomer is not particularly limited, and may be appropriately selected according to the intended purpose. The polymerizable monomer is preferably a radically polymerizable monomer including a carbon-carbon double bond in a molecule of the radically polymerizable monomer.

As the radically polymerizable monomer, a monofunctional radically polymerizable monomer, a polyfunctional radically polymerizable monomer, or a combination of the foregoing monomers may be used.

Examples of the radically polymerizable monomer include (meth)acrylates, styrene-based monomers, vinyl ethers, vinyl amides, maleimide-based monomers, and the like. Among the above-listed examples, (meth)acrylates are particularly preferred.

### —(Meth)acrylate—

As the (meth)acrylate, a monofunctional (meth)acrylic monomer or a polyfunctional (meth)acrylic monomer is used.

As the monofunctional (meth)acrylic monomer, (meth)acrylic acid or a (meth)acrylic monomer including one (meth)acrylic group may be listed. Examples of the monofunctional (meth)acrylic monomer include phenoxyethyl (meth)acrylate, tetrahydrofurfuryl (meth)acrylate, 2-hydroxyethyl (meth)acrylate, 4-hydroxybutyl (meth)acrylate, isobutyl (meth)acrylate, t-butyl (meth)acrylate, isooctyl (meth)acrylate, 2-methoxyethyl (meth)acrylate, methoxy triethylene glycol (meth)acrylate, 2-ethoxyethyl (meth)acrylate, 3-methoxybutyl (meth)acrylate, ethoxyethyl (meth)acrylate, butoxyethyl (meth)acrylate, ethoxy-diethylene glycol (meth)acrylate, methoxydixylethyl (meth)acrylate, ethylene diglycol (meth)acrylate, cyclic trimethylolpropane formal mono(meth)acrylate, imide (meth)acrylate, isoamyl (meth)acrylate, ethoxylated succinic acid (meth)acrylate, trifluoroethyl (meth)acrylate, ω-carboxypolycaprolactone mono(meth)acrylate, N-vinylformamide, cyclohexyl (meth)acrylate, benzyl (meth)acrylate, methylphenoxyethyl (meth)acrylate, 4-t-butylcyclohexyl (meth)acrylate, caprolactone-modified tetrahydrofurfuryl (meth)acrylate, tribromophenyl (meth)acrylate, ethoxylated tribromophenyl (meth)acrylate, 2-phenoxyethyl (meth)acrylate, (meth)acryloyl morpholine, phenoxydiethylene glycol (meth)acrylate, 2-hydroxy-3-phenoxypropyl (meth)acrylate, 1,4-cyclohexanedimethanol mono(meth)acrylate, 2-(2-ethoxyethoxy)ethyl (meth)acrylate, stearyl (meth)acrylate, diethylene glycol monobutyl ether (meth)acrylate, lauryl (meth)acrylate, isodecyl (meth)acrylate, 3,3,5-trimethylcyclohexanol (meth)acrylate, isooctyl (meth)acrylate, octyl/decyl (meth)acrylate, tridecyl (meth)acrylate, caprolactone (meth)acrylate, ethoxylated (4) nonylphenol (meth)acrylate, methoxypolyethylene glycol (350) mono(meth)acrylate, methoxypolyethylene glycol (550) mono(meth)acrylate, stearyl (meth)acrylate, ethoxy-diethylene glycol (meth)acrylate, 2-ethylhexyl-digycol (meth)acrylate, phenoxyethyl (meth)acrylate, isobornyl (meth)acrylate, 2-hydroxybutyl (meth)acrylate, and the like. The above-listed examples may be used alone or in combination.

Examples of the polyfunctional (meth)acrylic monomer include (meth)acrylic monomers including two (meth)acrylic groups, trifunctional or higher (meth)acrylic monomers, and the like.

Examples of the di(meth)acrylic monomer including two (meth)acrylic groups include 1,3-butylene glycol di(meth)acrylate, 1,4-butanediol di(meth)acrylate, diethylene glycol di(meth)acrylate, 1,6-hexanediol di(meth)acrylate, polyethylene glycol(200) di(meth)acrylate, tetraethylene glycol di(meth)acrylate, triethylene glycol di(meth)acrylate, tripropylene glycol di(meth)acrylate, polyethylene glycol(400) di(meth)acrylate, ethoxylated(3) bisphenol A di(meth)acrylate, dipropylene glycol di(meth)acrylate, alkoxylated hexanediol di(meth)acrylate, ethoxylated(4) bisphenol A di(meth)acrylate, ethoxylated(10) bisphenol A di(meth)acrylate, polyethylene glycol(600) di(meth)acrylate, tricyclodecane dimethanol di(meth)acrylate, 1,9-nonanediol di(meth)acrylate, 1,10-decanediol di(meth)acrylate, neopentyl glycol di(meth)acrylate, polytetramethylene glycol di(meth)acrylate, 3-methyl-1,5-pentanediol di(meth)acrylate, dimethylol-tricyclodecane di(meth)acrylate, neopentyl glycol-modified trimethylol propane di(meth)acrylate, stearic acid-modified pentaerythritol di(meth)acrylate, ethoxylated tripropylene glycol di(meth)acrylate, ethoxylated neopentyl glycol di(meth)acrylate, propoxylated neopentyl glycol di(meth)acrylate, tripropylene glycol di(meth)acrylate, dimethylol-tricyclodecane di(meth)acrylate, and the like. The above-listed examples may be used alone or in combination.

Examples of the trifunctional or higher (meth)acrylic monomer include trimethylol propane tri(meth)acrylate, hydroxypivalic acid trimethylolpropane tri(meth)acrylate, ethoxylated phosphoric acid tri(meth)acrylate, pentaerythritol tri(meth)acrylate, tetramethylolpropane tri(meth)acrylate, tetramethylolmethane tri(meth)acrylate, pentaerythritol tetra(meth)acrylate, caprolactone-modified trimethylolpropane tri(meth)acrylate, propoxylate glyceryl tri(meth)acrylate, tetramethylolmethane tetra(meth)acrylate, pentaerythritol tetra(meth)acrylate, ditrimethylolpropane tetra(meth)acrylate, ethoxylated pentaerythritol tetra(meth)acrylate, dipentaerythritol hexa(meth)acrylate, caprolactone-modified dipentaerythritol hexa(meth)acrylate, dipentaerythritol hydroxypenta(meth)acrylate, neopentyl glycol oligo(meth)acrylate, 1,4-butanediol oligo(meth)acrylate, hydroxypivalic acid neopentyl glycol acrylate adducts, 1,6-hexanediol oligo(meth)acrylate, trimethylolpropane oligo(meth)acrylate, pentaerythritol oligo(meth)acrylate, ethoxylated trimethylolpropane tri(meth)acrylate, propoxylated trimethylolpropane tri(meth)acrylate, 2-(2-vinyloxyethoxy)ethyl acrylate, 2-ethyl-2 (hydroxymethyl)-1,3-propanediol tri(meth)acrylate, ethoxylated trimethylolpropane tri(meth)acrylate, and the like. The above-listed examples may be used alone or in combination.

### —Styrene-Based Monomer—

As the styrene-based monomer, a monofunctional styrene-based monomer or polyfunctional styrene-based monomer is used.

Examples of the monofunctional styrene-based monomer include styrene derivatives substituted with a group that does not associate with a radical reaction, and the like. Examples of the monofunctional styrene-based monomer include: styrenes; x-alkyl styrene (the number of carbon atoms of alkyl is preferably from 1 to 4), such as α-methyl styrene; halogen-substituted styrenes, such as p-chlorostyrene and p-bromostyrene; alkyl-substituted styrenes (the number of carbon atoms of alkyl is preferably 1 to 12, more preferably 1 to 4), such as 4-methyl styrene and 4-ethyl styrene; alkoxy-substituted styrenes (the number of carbon atoms of alkoxy is preferably 1 to 12, more preferably 1 to 4), such as p-methoxystyrene; styrene-polyoxyalkylene adducts, such as vinylbenzyl-w-methyl polyoxyethylene oxide; hydroxyl group-substituted styrene, such as hydroxy styrene; and the like. The above-listed examples may be used alone or in combination.

Examples of the polyfunctional styrene-based monomer include vinyl group-substituted styrenes, such as 1,3-divinylbenzene and 1,4-divinylbenzene, and the like.

### —Vinyl Ether—

As the vinyl ether, a monofunctional vinyl ether or polyfunctional vinyl ether is used.

Examples of the monofunctional vinyl ether include: linear vinyl ethers, such as methyl vinyl ether, ethyl vinyl ether, trifluoroethyl vinyl ether, n-propyl vinyl ether, isopropyl vinyl ether, n-butyl vinyl ether, isobutyl vinyl ether, t-butyl vinyl ether, 2-methoxyethyl vinyl ether, and diethylene glycol ethylvinyl ether; alicyclic ring-containing vinyl ethers, such as cyclohexyl vinyl ether, and 2-(vinyloxy)tetrahydropyran; aromatic ring-containing vinyl ethers, such as phenyl vinyl ether, benzyl vinyl ether, and 4-methoxybenzyl vinyl ether; and the like. The above-listed examples may be used alone or in combination.

Examples of the polyfunctional vinyl ether include: linear vinyl ethers, such as diethylene glycol divinyl ether, divinyl ether, 1,4-butanediol divinyl ether, 1,6-hexanediol divinyl ether, triethylene glycol divinyl ether, and bis(vinyloxybutyl) succinate; alicyclic ring-containing vinyl ethers, such as 1,4-cyclohexane dimethanol divinyl ether; aromatic ring-containing vinyl ethers, such as bis[4-(vinyloxy)butyl]terephthalate; and the like. The above-listed examples may be used alone or in combination.

### —Vinylamide—

Examples of a monofunctional vinylamide serving as the monofunctional radically polymerizable monomer include: linear vinylamides, such as N-vinylformamide, N-vinylacetoamide, N-methyl-N-vinylformamide, and N-methyl-N-vinylacetoamide; alicyclic ring-containing vinylamides, such as N-vinylpyrrolidone, N-vinyl-a-caprolactam, and 5-methyl-3-vinyloxazolidin-2-one; and the like. The above-listed examples may be used alone or in combination.

### —Maleimide-Based Monomer—

As the maleimide-based monomer, a monofunctional maleimide-based monomer including one maleimide group or polyfunctional maleimide-based monomer including two or more maleimide groups may be used.

Examples of the monofunctional maleimide-based monomer include: maleimides; aliphatic hydrocarbon group-containing maleimides, such as methyl maleimide, ethyl maleimide, propyl maleimide, butyl maleimide, hexyl maleimide, octyl maleimide, dodecyl maleimide, stearyl maleimide, and cyclohexyl maleimide; aromatic ring-containing maleimides, such as phenyl maleimide; and the like. The above-listed examples may be used alone or in combination.

Examples of the polyfunctional maleimide-based monomer include: aliphatic hydrocarbon group-containing maleimides, such as 1,2-bis(maleimide) ethane, 1,4-bis(maleimide) butane, and 2,2′-(ethylenedioxy)bis(ethylmaleimide); aromatic ring-containing maleimides, such as N,N′-m-phenylenebismaleimide, N,N′-p-phenylenebismaleimide, and 1,1′-(methylenedi-4,4′-phenylene)bismaleimide; and the like. The above-listed examples may be used alone or in combination.

### —Other Polymerizable Monomers—

Examples of other polymerizable monomers include: fluorine-containing vinyl monomers, such as perfluoroethylene, perfluoropropylene, and vinylidene fluoride; silicon-containing vinyl monomers, such as vinyltrimethoxysilane and vinyltriethoxysilane; maleic anhydrides, maleic acid, and monoalkyl esters and dialkyl esters, such as monoalkyl esters and dialkyl esters of maleic acid; fumaric acid, and monoalkyl esters and dialkyl esters of fumaric acid; nitrile-containing vinyl monomers, such as acrylonitrile, methacrylonitrile; amide-containing vinyl monomers of vinyl esters (e.g., vinyl acetate, vinyl propionate, vinyl pivalate, vinyl benzoate, vinyl cinnamate, etc.); alkenes, such as ethylene, and propylene; vinyl chloride; vinylidene chloride; allyl chloride; allyl alcohol; and the like. The above-listed examples may be used alone or in combination.

The amount of the polymerizable monomer is preferably 80% by mass or greater and 97% by mass or less, more preferably 85% by mass or greater and 95% by mass or less, relative to a total amount of the curable composition.

### <Quaternary Boron-Containing Onium Salt>

The quaternary boron-containing onium salt is composed of an organic boron anion and a cation, as represented by General Formula (1) below.

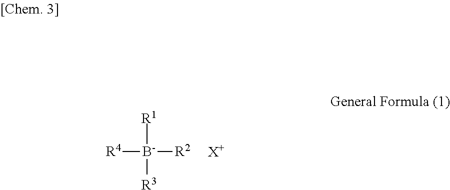

In General Formula (1), at least one of R¹ to R⁴ is a phenyl group or naphthyl group that may have a substituent, and the rest of R¹ to R⁴ are each an alkyl group that may have a substituent, or a phenyl group or naphthyl group that may have a substituent; and X⁺ is an ammonium cation, a sulfonium cation, a pyridinium cation, a phosphonium cation, an oxonium cation, or an iodonium cation.

The alkyl group is preferably an alkyl group in which the number of carbon atoms is preferably 1 to 18. Examples of the alkyl group include a methyl group, an ethyl group, a propyl group, an isopropyl group, a butyl group, an isobutyl group, a sec-butyl group, a tert-butyl group, a pentyl group, a hexyl group, an octyl group, a decyl group, a stearyl group, and the like.

For example, the alkyl group, phenyl group, or naphthyl group may be substituted with a halogen atom, a cyano group, an acyloxy group, an acyl group, an alkoxy group, or a hydroxy group.

Examples of the organic boron anion include a triaryl monoalkyl boron anion, and the like. Examples of the triaryl monoalkyl boron compound include triphenylmethylborate, triphenylethylborate, triphenylpropylborate, triphenylisopropylborate, triphenylbutylborate, triphenylisobutylborate, triphenyl-sec-butylborate, triphenyl-tert-butylborate, tris(p-tolyl)butylborate, trimesitylbutylborate, tris(p-anisil)butylborate, tris(2,4,5-trifluorophenyl)butylborate, tris(pentafluorophenyl)butylborate, and the like. The above-listed examples may be used alone or in combination.

X⁺ is an ammonium cation, a sulfonium cation, a pyridinium cation, a phosphonium cation, an oxonium cation, or an iodonium cation. A structure of the substituent of the cation is not restricted. Examples of the substituent of the cation include an alkyl group, an alkoxy group, a phenyl group, and the like.

Each of the ammonium cation, sulfonium cation, pyridinium cation, phosphonium cation, oxonium cation, and iodonium cation may have a substituent, or may be linked to form a ring.

Examples of the ammonium cation include: alkyl group-containing ammonium cations, such as tetramethylammonium, tetraethylammonium, tetrapropylammonium, tetraisopropylammonium, tetrabutylammonium, tetra-sec-butylammonium, tetra-tert-butylammonium, tetrapentylammonium, tetraisopentylammonium, tetraneopentylammonium, and tetra-tert-pentylammonium; hydrogen-containing ammonium cations, such as tetraammonium hydrogen, trimethylammonium hydrogen, triethylammonium hydrogen, tripropylammonium hydrogen, tripropylammonium hydrogen, tributylammonium hydrogen, and tripentylammonium hydrogen; benzyl group-containing ammonium cations, such as benzyltrimethylammonium, benzyltriethylammonium, benzyltripropylammonium, benzyltributylammonium, benzyltripentylammonium, phenyltrimethylammonium, phenyltriethylammonium, phenyltripropylammonium, phenyltributylammonium, and phenyltripentylammonium; vinyl group-containing ammonium cations, such as trimethylvinylammonium, triethylvinylammonium, tripropylvinylammonium, tributylvinylammonium, and tripentylvinylammonium; allyl group-containing ammonium cations, such as trimethylallylammonium, triethylallylammonium, tripropylallylammonium, tributylallylammonium, tripentylallylammonium, dimethyldiallylammonium, diethyldiallylammonium, dipropyldiallylammonium, dibutyldiallylammonium, and dipentyldiallylammonium; alkoxyalkyl group-containing ammonium cations, such as (2-methoxyethoxymethyl)trimethylammonium, (2-methoxyethoxymethyl)triethylammonium, (2-methoxyethoxymethyl)tripropylammonium, (2-methoxyethoxymethyl)tributylammonium, and (2-methoxyethoxymethyl)tripentylammonium; hexamethonium, decamethonium, ferrocenylmethyltrimethylammonium, ferrocenylmethyltriethylammonium, ferrocenylmethyltripropylammonium, ferrocenylmethyltributylammonium, ferrocenylmethyltripentylammonium; and the like. The above-listed examples may be used alone or in combination.

Examples of the sulfonium cation include trimethyl sulfonium cations, triphenyl sulfonium cations, diphenyl[4-(phenylthio)phenyl]sulfonium cations, and the like. The above-listed examples may be used alone or in combination.

Examples of the pyridinium cation include methyl pyridinium cations, phenyl pyridinium cations, and the like. The above-listed examples may be used alone or in combination.

Examples of the phosphonium cation include tetramethyl phosphonium cations, tetraethyl phosphonium cations, tetra-n-propyl phosphonium cations, tetra-n-butyl phosphonium cations, tetraphenyl phosphonium cations, and the like. The above-listed examples may be used alone or in combination.

Examples of the oxonium cation include trimethyl oxonium cations, phenyldimethyl oxonium cations, and the like. The above-listed examples may be used alone or in combination.

Examples of the iodonium cation include diphenyl iodonium cations, 4-isopropyl-4′-methyldiphenyl iodonium cations, bis(4-t-butylphenyl) iodonium cations, diphenylene iodonium cations, and the like. The above-listed examples may be used alone or in combination.

The quaternary boron-containing onium salt may be appropriately synthesized for use. Alternatively, a commercial product of the quaternary boron-containing onium salt may be used. Examples of the commercial product include P3B and N3B (both available from Showa Denko K. K.), tetraphenylphosphonium tetraphenylborate (available from Tokyo Chemical Industry Co., Ltd.), and the like.

The amount of the quaternary boron-containing onium salt is preferably 0.1% by mass or greater and 5% by mass or less, more preferably 18 by mass or greater and 5% by mass or less, relative to a total amount of the curable composition.

### <Aluminum Chelate Compound>

Examples of the aluminum chelate compound include a complex compound represented by General Formula (2), where three B-keto enolate anions are coordinated to aluminum, and the like. In the complex compound represented by General Formula (2), an alkoxy group is not directly bonded to aluminum. If the alkoxy group is directly bonded to aluminum, hydrolysis is likely to occur, thus use of such an aluminum chelate compound is not suitable for an emulsification process.

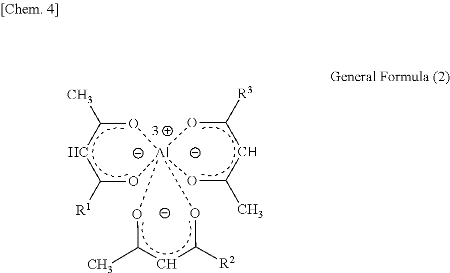

In General Formula (2), R¹, R², and R³ are each independently an alkyl group or an alkoxy group.

Examples of the alkyl group include a methyl group, an ethyl group, and the like.

Examples of the alkoxy group include a methoxy group, an ethoxy group, an oleyloxy group, and the like.

Examples of the complex compound represented by General Formula (2) include aluminum tris(acetylacetonate), aluminum tris(ethylacetoacetate), aluminum monoacetylacetonate bis(ethylacetoacetate), aluminum monoacetylacetonate bis(oleylacetoacetate), and the like.

The amount of the aluminum chelate compound is preferably 0.1% by mass or greater and 10% by mass or less, more preferably 1% by mass or greater and 5% by mass or less, relative to a total amount of the curable composition.

For assuring excellent pot life, the aluminum chelate compound is preferably borne on porous particles (porous particles bearing the aluminum chelate compound).

The porous particles are each formed of a polyurea resin.

For example, each of the porous particles bears the aluminum chelate compound inside pores of the porous particle. In other words, the aluminum chelate compound is captured and borne inside fine pores present within each porous particle matrix formed of a polyurea resin.

The polyurea resin is a resin including a urea bond in a molecular structure of the resin.

For example, the polyurea resin forming each of the porous particles may be obtained by polymerizing a polyfunctional isocyanate compound in an emulsion. The details will be described later. The polyurea resin may include, in a molecular structure of the resin, a bond that is derived from an isocyanate group but is not a urea bond, such as, a urethane bond. When a urethane bond is included, the resin may be referred to as a polyurethane resin.

The amount of the aluminum chelate compound in the porous particles is not particularly limited, and may be appropriately selected according to the intended purpose.

The mean pore diameter of the pores of the porous particles is not particularly limited, and may be appropriately selected according to the intended purpose. The mean pore diameter is preferably 1 nm or greater and 300 nm or less, more preferably 5 nm or greater and 150 nm or less.

The amount of the porous particles bearing the aluminum chelate compound is preferably 0.1% by mass or greater and 10% by mass or less, more preferably 1% by mass or greater and 5% by mass or less, relative to a total amount of the curable composition.

A method for producing the porous particles each bearing the aluminum compound includes a porous particle production step and a coating step, and may further include other steps, as necessary.

### <<Porous Particle Production Step>>

The porous particle production step includes at least an emulsion production process and a polymerization process. The porous particle production step preferably further includes an additional filling process, and may further include other processes, as necessary.

### —Emulsion Production Process—

The emulsion production process is not particularly limited, except that the emulsion production process is a process including emulsifying a liquid, which is obtained by mixing an aluminum chelate compound, a polyfunctional isocyanate compound, and preferably an organic solvent, to obtain an emulsion. The emulsion production process may be appropriately selected according to the intended purpose. For example, the emulsion production process can be performed by a homogenizer.

The size of droplets in the emulsion is not particularly limited, and may be appropriately selected according to the intended purpose. The size of droplets is preferably 0.5 μm or greater and 100 μm or less.

The polyfunctional isocyanate compound is a compound including two or more isocyanate groups, preferably three isocyanate groups per molecule. Preferred examples of the trifunctional isocyanate compound include a TMP adduct represented by General Formula (3) obtained by reacting trimethylol propane (1 mol) and a diisocyanate compound (3 mol), an isocyanurate represented by General Formula (4) obtained by self-condensing a diisocyanate compound (3 mol), and a biuret represented by General Formula (5) obtained by condensing a diisocyanate urea, which is obtained from 2 moles of a diisocyanate compound out of 3 moles of the diisocyanate compound, with the 1 mole of the diisocyanate compound that is the remainder of the 3 moles of the diisocyanate compound.

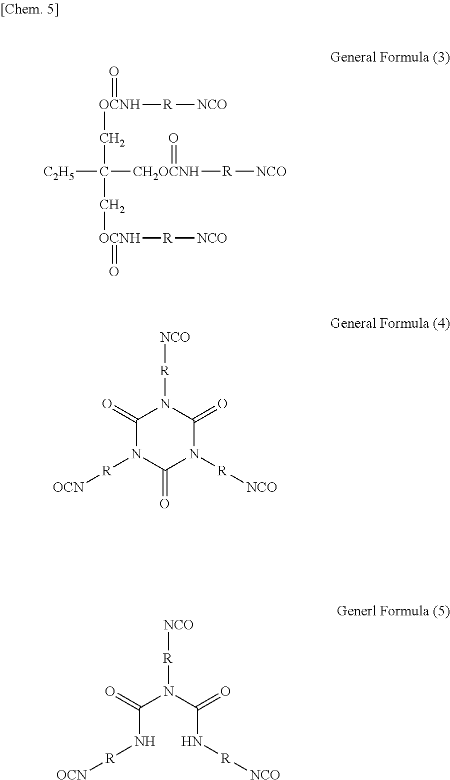

In General Formulae (3) to (5), the substituent R is a segment of a diisocyanate compound from which an isocyanate group is removed. Examples of the diisocyanate compound include toluene-2,4-diisocyanate, toluene-2,6-diisocyanate, m-xylylene diisocyanate, hexamethylene diisocyanate, hexahydro-m-xylylene diisocyanate, isophorone diisocyanate, methylenediphenyl-4,4′-diisocyanate, and the like.

The blending ratio between the aluminum chelate compound and the polyfunctional isocyanate compound is not particularly limited, and may be appropriately selected according to the intended purpose. If the blended amount of the aluminum chelate is too small, curability of the cationic curable compound to be cured is reduced. If the blended amount of the aluminum chelate is too large, latentability of a resulting latent curing agent is reduced. Considering the point as described, the amount of the aluminum chelate is preferably 10 parts by mass or greater and 500 parts by mass or less, more preferably 10 parts by mass or greater and 300 parts by mass or less, relative to 100 parts by mass of the polyfunctional isocyanate compound.

The organic solvent is not particularly limited, and may be appropriately selected according to the intended purpose. The organic solvent is preferably a volatile organic solvent.

The organic solvent is preferably an organic solvent that is a good solvent (solubility is preferably 0.1 g/mL (organic solvent) or greater) for each of the aluminum chelate compound and the polyfunctional isocyanate compound, is substantially insoluble (solubility of water is 0.5 g/mL (organic solvent) or less) in water, and has a boiling point of 100° C. or lower at atmospheric pressure. Specific examples of the above-described volatile organic solvent include alcohols, acetic acid esters, ketones, and the like. Among the above-listed examples, ethyl acetate is preferred in view of high polarity, a low boiling point, and low water solubility.

The amount of the organic solvent used is not particularly limited, and may be appropriately selected according to the intended purpose.

### —Polymerization Process—

The polymerization process is not particularly limited, except that the polymerization process is a process where the polyfunctional isocyanate compound is polymerized in the emulsion to yield porous particles. The polymerization process may be appropriately selected according to the intended purpose.

In the polymerization process, part of the isocyanate groups of the polyfunctional isocyanate compound is transformed to an amino group through hydrolysis, and the amino group and the isocyanate group of the polyfunctional isocyanate compound are reacted to generate a urea bond, to thereby form a polyurea resin. In the case where the polyfunctional isocyanate compound includes a urethane bond, a resulting polyurea resin also includes a urethane bond. Therefore, the resulting polyurea resin may be also referred to as a polyurea-urethane resin.

The polymerization time of the polymerization process is not particularly limited, and may be appropriately selected according to the intended purpose. The polymerization time is preferably 1 hour or longer and 30 hours or shorter, more preferably 2 hours or longer and 10 hours or shorter. The polymerization temperature of the polymerization process is not particularly limited, and may be appropriately selected according to the intended purpose. The polymerization temperature is preferably 30° C. or higher and 90° C. or lower, more preferably 50° C. or higher and 80° C. or lower.

The obtained porous particles each bearing the aluminum compound are optionally separated by filtration, washed, and dried, followed by grinding into primary particles by any of grinders known in the related art.

### <Silanol Compound>

Examples of the silanol compound include triethylsilanol, dimethylphenylsilanol, trifluoromethylphenylsilanol, an arylsilanol compound represented by General Formula (6), and the like. Among the above-listed examples, an arylsilanol compound represented by General Formula (6) is preferred.

[Chem. 6]

(Ar)ₘSi(OH)ₙ General Formula (6)

In General Formula (6), m is 2 or 3, preferably 3, where a sum of m and n is 4; and Ar is an aryl group that may have a substituent.

The arylsilanol compound represented by General Formula (6) is a mono-ol or a diol.

In General Formula (6), Ar is an aryl group that may have a substituent.

Examples of the aryl group include a phenyl group, a naphthyl group (e.g., a 1-naphthyl group, a 2-naphthyl group, etc.), an anthracenyl group (e.g., a 1-anthracenyl group, a 2-anthracenyl group, a 9-anthracenyl group, a benz[a]-9-anthracenyl group, etc.), a phenaryl group (e.g., a 3-phenaryl group, a 9-phenaryl group, etc.), a pyrenyl group (e.g., a 1-pyrenyl group, etc.), an azulenyl group, a fluorenyl group, a biphenyl group (e.g., a 2-biphenyl group, a 3-biphenyl group, a 4-biphenyl group, etc.), a thienyl group, a furyl group, a pyrrolyl group, an imidazolyl group, a pyridyl group, and the like. The above-listed examples may be used alone or in combination. Among the above-listed examples, a phenyl group is preferred in view of ready availability and cost. The number “m” of Ar may be mutually identical or different, but all of Ar is preferably the same in view of ready availability.

For example, the above-mentioned aryl groups may each include one to three substituents.

Examples of the substituents include electron-withdrawing groups, electron-donating groups, and the like.

Examples of the electron-withdrawing groups include halogen groups (e.g., chloro groups, bromo groups, etc.), trifluoromethyl groups, nitro groups, sulfo groups, carboxyl groups, alkoxycarbonyl groups (e.g., methoxycarbonyl groups, ethoxycarbonyl groups, etc.), formyl groups, and the like.

Examples of the electron-donating groups include alkyl groups (e.g., methyl groups, ethyl groups, propyl groups, etc.), alkoxy groups (e.g., methoxy groups, ethoxy groups, etc.), hydroxy groups, amino groups, monoalkylamino groups (e.g., monomethylamino groups, etc.), dialkylamino groups (e.g., dimethylamino groups, etc.), and the like.

Specific examples of the phenyl group having a substituent include a 2-methylphenyl group, a 3-methylphenyl group, a 4-methylphenyl group, a 2,6-dimethylphenyl group, a 3,5-dimethylphenyl group, a 2,4-dimethylphenyl group, a 2,3-dimethylphenyl group, a 2,5-dimethylphenyl group, a 3,4-dimethylphenyl group, a 2,4,6-trimethylphenyl group, a 2-ethylphenyl group, a 4-ethylphenyl group, and the like.

Acidity of a hydroxyl group of a silanol group can be increased when an electron-withdrawing group is used as a substituent. Acidity of a hydroxyl group of a silanol group can be reduced when an electron-donating group is used as a substituent.

The number “m” of Ar may each have different substituents, but the number “m” of Ar preferably have the same substituents in view of ready availability. Moreover, part of Ar may have substituents, and the rest of Ar may not have substituents.

Among the above-listed examples, triphenylsilanol and diphenylsilane diol are preferred, and triphenylsilanol is particularly preferred.

The amount of the silanol compound is preferably 0.1% by mass or greater and 10% by mass or less, more preferably 1% by mass or greater and 5% by mass or less, relative to a total amount of the curable composition.

### <Other Components>

The above-mentioned other components are not particularly limited, and may be appropriately selected according to the intended purpose. Examples of the above-mentioned other components include pigments, dyes, organic or inorganic fillers, antistatic agents, defoaming agents, viscosity modifiers, light-resistant stabilizers, weather-resistant stabilizers, heat-resistant stabilizers, UV absorbers, antioxidants, leveling agents, pigment dispersing agents, wax, and the like.

### (Cured Product)

The cured product of the present invention is obtained by heating the curable composition of the present invention to cure the curable composition. The heating conditions are not particularly limited, and may be appropriately selected according to the intended purpose. For example, the heating is carried out at a temperature of 60° C. to 150° C. for 5 minutes to 15 minutes in an oven, or for 1 minute to 5 minutes on a hotplate.

The polymer (cured product) obtained by heating the curable composition of the present invention may be any form of a polymer. The polymer may include a homopolymer, a copolymer that is not a block copolymer, or a block polymer. The polymer is preferably a homopolymer or a copolymer that is not a block copolymer. The “copolymer that is not a block copolymer” encompasses random copolymers, alternating copolymers, and all copolymers obtained by sequentially polymerizing several types of monomers.

### <Use>

Since the curable composition of the present invention has excellent curability as heated, the curable composition of the present invention can be widely used in various fields, such as coating materials, adhesives for optical members, sealants for electronic components, hard coating agents for various plastic substrates of automobiles, electric appliances, mobile phones, etc., top coat agents for paper, etc., binders for printing inks, solder resists, and the like.

### EXAMPLES

Examples of the present invention will be described hereinafter, but these examples shall not be construed as limiting the scope of the present invention in any way.

### Preparation Example 1

### <Preparation of Porous Particles Each Bearing Aluminum Chelate Compound>

### —Preparation of Aqueous Phase—

A 3 L interfacial polymerization container equipped with a thermometer was charged with 800 parts by mass of distilled water, 0.05 parts by mass of a surfactant (NEWREX R-T, available from NOF CORPORATION), and 4 parts by mass of polyvinyl alcohol (PVA-205, available from KURARAY CO., LTD.) serving as a dispersing agent. The resulting mixture was homogeneously mixed to prepare an aqueous phase.

### —Preparation of Oil Phase—

Next, 100 parts by mass of a 24% by mass aluminum monoacetylacetonate bis(ethylacetoacetate) isopropanol solution (Aluminum Chelate D, available from Kawaken Fine Chemicals Co., Ltd.) and 70 parts by mass of a methylenediphenyl-4,4′-diisocyanate (3 mol) trimethylol propane (1 mol) adduct (polyfunctional isocyanate compound, D-109, available from Mitsui Chemicals, Inc.) were dissolved in 130 parts by mass of ethyl acetate to prepare an oil phase.

### —Emulsification—

The prepared oil phase was added to the previously prepared aqueous phase, and the resulting mixture was mixed and emulsified by a homogenizer (10,000 rpm/5 min: T-50, available from IKA Japan K.K.) to yield an emulsion.

—Polymerization—Polymerization of the prepared emulsion was carried out at 80° C. for 6 hours while stirring at 200 rpm. After completing the reaction, the polymerization reaction liquid was left to cool down to room temperature (25° C.). The generated polymerized resin particles (porous particles) were separated by filtration, followed by washing the polymerized resin particles with distilled water through filtration. The resulting polymerized resin particles were air-dried at room temperature (25° C.) to thereby obtain bulks of porous particles. The bulks of porous particles were ground into primary particles by a grinder (A-O Jet Mill, available from SEISHIN ENTERPRISE Co., Ltd.), to thereby obtain porous particles each bearing an aluminum chelate compound of Preparation Example 1.

### Examples 1 to 16 and Comparative Examples 1 to 5

The components of each of the compositions presented in Tables 1 to 3 were mixed to prepare a curable composition of each of Examples 1 to 16 and Comparative Examples 1 to 5.

Next, each of the obtained curable compositions was evaluated on an “exothermic peak temperature” and “pot life” in the following manner. The results are presented in Tables 1 to 3.

### <Exothermic Peak Temperature>

Each of the obtained curable compositions was measured at a heating rate of 10° C./min by a differential scanning calorimeter (DSC7000X, available from Hitachi High-Tech Science Corporation). The sample that exhibited exothermic behaviors was judged as being cured, and an exothermic peak temperature of the sample exhibiting exothermic behaviors was measured and presented in the tables.

The reaction onset temperature measured by DSC indicates a curing onset temperature. The exothermic peak temperature indicates a temperature at which the curing reaction becomes the most active. The reaction end temperature indicates a curing end temperature. The peak area indicates an amount of heat generated.

### <Evaluation of Pot Life>

An initial amount of generated heat of each of the obtained curable compositions when the components presented in Tables 1 to 3 were initially added together, and an amount of generated heat of each of the curable compositions after being left to stand at 23° C. for 72 hours were measured by a differential scanning calorimeter (DSC7000X, available from Hitachi High-Tech Science Corporation). A case where the amount of generated heat of the curable composition after being left to stand at 23° C. for 72 hours was reduced by 20% or greater compared to the initial amount of generated heat was evaluated as “x,” as pot life of the curable composition was not good. A case where the amount of generated heat of the curable composition after being left to stand at 23° C. for 72 hours was reduced by 15% or greater and less than 20% compared to the initial amount of generated heat was evaluated as “Δ,” as pot life of the curable composition was at an expected level. A case where the amount of generated heat of the curable composition after being left to stand at 23° C. for 72 hours was reduced by less than 15% compared to the initial amount of generated heat was evaluated as “∘,” as pot life of the curable composition was good.

TABLE 1

| | | Comp. | Ex. | | | | | | | |
|---|---|---|---|---|---|---|---|---|---|---|
| | | Ex. 1 | 1 | 2 | 3 | 4 | 5 | 6 | 7 | 8 |
| Polymerizable | DCP-A | 95 | 95 | 95 | 95 | 80 | 97 | — | 50 | 95 |
| monomer | AT-20E | — | — | — | — | — | — | — | — | — |
| | IBXA | — | — | — | — | — | — | 95 | 45 | — |
| Quaternary | P3B | — | 5 | 5 | — | 5 | 1 | 5 | — | — |
| boron-containing | N3B | — | — | — | 5 | — | — | — | 5 | — |
| onium salt | 4P4B | — | — | — | — | — | — | — | — | 5 |
| Organic peroxide | AIBN | 5 | — | — | — | — | — | — | — | — |
| Aluminum chelatel | Aluminum mono- | — | — | 4 | — | — | — | — | — | — |
| compound | acetylacetonate | | | | | | | | | |
| | bis(ethylacetoacetate) | | | | | | | | | |
| | Porous particles of | — | 4 | — | 4 | 10 | 1 | 4 | 4 | 4 |
| | Preparation Example 1 | | | | | | | | | |
| Silanol compound | TPS | — | 8 | 8 | 8 | 10 | 3 | 8 | 8 | 8 |
| Total (parts by mass) | | 100 | 112 | 112 | 112 | 105 | 100 | 112 | 112 | 112 |
| Evaluation | Exothermic temperature | 90.1 | 80.2 | 58.7 | 80.9 | 78.9 | 88.8 | 87.6 | 85.4 | 80.3 |
| results | (° C.) | | | | | | | | | |
| | Pot life | x | ∘ | Δ | ∘ | ∘ | ∘ | ∘ | ∘ | ∘ |

TABLE 2

| | | Comp. | Ex. | | | | | | | |
|---|---|---|---|---|---|---|---|---|---|---|
| | | Ex. 2 | 9 | 10 | 11 | 12 | 13 | 14 | 15 | 16 |
| Polymerizable | DCP-A | — | — | — | — | — | — | — | — | — |
| monomer | AT-20E | 95 | 95 | 95 | 95 | 80 | 97 | — | 50 | 95 |
| | IBXA | — | — | — | — | — | — | 95 | 45 | — |
| Quaternary | P3B | — | 5 | 5 | — | 5 | 1 | — | — | — |
| boron-containing | N3B | — | — | — | 5 | — | — | 5 | 5 | — |
| onium salt | 4P4B | — | — | — | — | — | — | — | — | 5 |
| Organic peroxide | AIBN | 5 | — | — | — | — | — | — | — | — |
| Aluminum chelate | Aluminum mono- | — | — | 4 | — | — | — | — | — | — |
| compound | acetylacetonate | | | | | | | | | |
| | bis(ethylacetoacetate) | | | | | | | | | |
| | Porous particles of | — | 4 | — | 4 | 10 | 1 | 4 | 4 | 4 |
| | Preparation Example 1 | | | | | | | | | |
| Silanol compound | TPS | — | 8 | 8 | 8 | 10 | 1 | 8 | 8 | 8 |
| Total (parts by mass) | | 100 | 112 | 112 | 112 | 105 | 100 | 112 | 112 | 112 |
| Evaluation | Exothermic peak | 87.4 | 75.5 | 60.9 | 77.7 | 74 | 83.2 | 76.9 | 84.5 | 77.1 |
| results | temperature (° C.) | | | | | | | | | |
| | Pot life | x | ∘ | Δ | ∘ | ∘ | ∘ | ∘ | ∘ | ∘ |

TABLE 3

| | | Comp. Ex. 3 | Comp. Ex. 4 | Comp. Ex. 5 |
|---|---|---|---|---|
| Polymerizable monomer | DCP-A | 95 | 95 | 95 |
| | AT-20E | — | — | — |
| | IBXA | — | — | — |
| Quaternary boron- | P3B | — | 5 | 5 |
| containing onium salt | N3B | — | — | — |
| | 4P4B | — | — | — |
| Organic peroxide | AIBN | — | — | — |
| Aluminum chelate | Aluminum mono- | — | — | — |
| compound | acetylacetonate bis | | | |
| | (ethylacetoacetate) | | | |
| | Porous particles of | 4 | — | 4 |
| | Preparation Example | | | |
| | 1 | | | |
| Silanol compound | TPS | 8 | 8 | — |
| Total (parts by mass) | | 107 | 108 | 104 |
| Evaluation results | Exothermic peak | 168° C. | 145° C. | 134.9° C. |
| | temperature (° C.) | | | |
| | Pot life | Could not be | Could not be | Could not be |
| | | measured | measured | measured |

The details of each of the components in Tables 1 to 3 are 5 as follows.
DCP-A: dimethyloltricyclodecane diacrylate, available from KYOEISHA CHEMICAL CO., LTD.
AT-20E: ethoxylated trimethylolpropane triacrylate, available from SHIN-NAKAMURA CHEMICAL Co., Ltd.
IBXA: isobornyl acrylate, available from KYOEISHA CHEMICAL CO., LTD.
P3B: tetrabutylammonium butyltriphenylborate, available from Showa Denko K.K.
N3B: tetrabutylammonium butyltrinaphthylborate, available from Showa Denko K.K.
4P4B: tetraphenylphosphonium tetraphenylborate, available from Tokyo Chemical Industry Co., Ltd.
TPS: triphenylsilanol, available from Tokyo Chemical Industry Co., Ltd.
AIBN: azobis(isobutyronitrile), available from Tokyo Chemical Industry Co., Ltd.

### INDUSTRIAL APPLICABILITY

Since the curable composition of the present invention has excellent curability as heated, the curable composition of the present invention can be suitably used for various fields, such as coating materials, adhesives for optical members, sealants for electronic components, hard coating agents for various plastic substrates of automobile, electric appliances, mobile phones, etc., and the like.

1. A curable composition, comprising:
a polymerizable monomer;
an aluminum chelate compound;
a silanol compound; and
a quaternary boron-containing onium salt.

2. The curable composition according to claim 1,
wherein the polymerizable monomer is a radically polymerizable monomer including a carbon-carbon double bond in a molecule of the radically polymerizable monomer.

3. The curable composition according to claim 1, wherein the polymerizable monomer is a (meth)acrylate.

4. The curable composition according to claim 1, further comprising:
porous particles,
wherein the aluminum chelate compound is borne on the porous particles.

5. The curable composition according to claim 4,
wherein the porous particles are each formed of a polyurea resin.

6. The curable composition according to claim 1,
wherein the quaternary boron-containing onium salt is represented by General Formula (1) below, 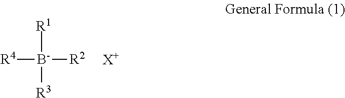
where, in General Formula (1), at least one of R¹ to R⁴ is a phenyl group or naphthyl group that may have a substituent, and the rest of R¹ to R⁴ are each an alkyl group that may have a substituent, or a phenyl group or naphthyl group that may have a substituent; and X⁺ is an ammonium cation, a sulfonium cation, a pyridinium cation, a phosphonium cation, an oxonium cation, or an iodonium cation.

7. The curable composition according to claim 1,
wherein the silanol compound is an arylsilanol compound represented by General Formula (6) below,
(Ar)ₘSi(OH)ₙ General Formula (6)
where, in General Formula (6), m is 2 or 3, where a sum of m and n is 4; and Ar is an aryl group that may have a substituent.

8. The curable composition according to claim 1,
wherein an amount of the polymerizable monomer is 80% by mass or greater and 97% by mass or less.

9. The curable composition according to claim 1,
wherein an amount of the aluminum chelate compound is 0.1% by mass or greater and 10% by mass or less.

10. The curable composition according to claim 1,
wherein an amount of the silanol compound is 0.1% by mass or greater and 10% by mass or less.

11. The curable composition according to claim 1,
wherein an amount of the quaternary boron-containing onium salt is 0.1% by mass or greater and 5% by mass or less.

12. A cured product, comprising:
a cured product of the curable composition according to claim 1 that is cured by heating.
